(19) United States
(12) Patent Application Publication
(10) Pub. No.: US 2010/0148382 A1
(43) Pub. Date: Jun. 17, 2010

(54) DEVICE FOR HOMOGENIZING FUEL IN THE GASES IN AN EXHAUST SYSTEM

(75) Inventors: Laurent Castaignede, Bordeaux (FR); David Pouget, Chennevieres Sur Marne (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Renault S.A.S., Boulogne Billancourt (FR)

(21) Appl. No.: 12/518,197

(22) PCT Filed: Nov. 26, 2007
(86) PCT No.: PCT/FR07/52396

§ 371 Date: Mar. 3, 2010

(30) Foreign Application Priority Data
Dec. 6, 2006 (FR) 0610637

(51) Int. Cl. B01F 5/04; B01F 3/02

(52) U.S. Cl. 261/76; 261/79.1

(57) ABSTRACT

A device for homogenizing fuel in the gases of an exhaust system, including: a substantially planar sealing surface surrounding a passage; and a deflector member projecting into the passage from the sealing surface and projecting with respect to the plan of the sealing surface, the sealing surface and the deflector member being formed as a single piece.

The invention relates in general to internal combustion engines provided with devices for filtering the burnt gases.

The invention relates more specifically to the exhaust systems that include an exhaust pipe and a fuel injector opening into this exhaust pipe.

The exhaust pipes of internal combustion engines are generally provided with an oxidation catalytic converter followed, in the direction in which the burnt gases flow, by a particulate filter.

The oxidation catalytic converter is intended to oxidize hydrocarbons and carbon monoxide resulting from the combustion of the fuel with fresh air in the combustion chamber, in order to prevent them from being discharged into the atmosphere, while the particulate filter is able to filter and store a significant proportion of the contaminating particles (soot) discharged by the engine.

When the particulate filter reaches a certain fill level, the burnt gases find it difficult to leave through the exhaust pipe, leading to a burnt-gases back pressure detrimental to the running of the internal combustion engine.

It is then necessary, during the particulate filter regeneration phase, to eliminate the polluting particles with which the filter is filled without thereby discharging them in that condition into the atmosphere but rather by burning them beforehand. To do that, fuel is injected into the exhaust system, leading to a highly exothermic oxidation reaction oxidizing the fuel in the oxidation catalytic converter. The burnt gases therefore leave the oxidation catalytic converter at a high temperature and enter the particulate filter, burning the polluting particles with which the latter is filled.

The known devices that implement such a method do exhibit disadvantages. The gas/fuel mixture achieved is relatively heterogeneous as it enters the catalytic converter, leading to nonoptimal regeneration of the particulate filter, to risk of damage to the particulate filter and to the vehicle having to be returned to the repair shop.

The invention aims to address one or more of these disadvantages. The invention therefore relates to a homogenizing device for homogenizing fuel in the gases of an exhaust system, which comprises:
a substantially planar sealing surface surrounding a passage;
a deflection member projecting into the passage from the sealing surface and projecting with respect to the plane of the sealing surface, the sealing surface and the deflection member being formed as a single piece.

According to one alternative form, the sealing surface and the deflection member are made of a metallic material.

According to yet another alternative form, the sealing surface and the deflection member are formed as a single piece by casting.

According to another alternative form, the sealing surface and the deflection member are formed as a single piece by pressing.

According to yet another alternative form, several of said deflection members extend right across the passage and each have a fin.

According to one alternative form, said fins are substantially mutually parallel.

According to yet another alternative form, the deflection member has a terminal part exhibiting a free edge and a tab that is inclined with respect to the sealing surface, the tab connecting the terminal part to the sealing surface and being of a width smaller than that of the terminal part.

According to another alternative form, the tab is twisted.

According to yet another alternative form, the deflection member extends across most of the passage and has a free edge.

The invention also relates to an exhaust system, comprising:
an exhaust pipe comprising first and second ducts assembled with one another;
a homogenizing device as described hereinabove, the sealing surface of which is compressed between the first and second ducts and the passage of which places the inside of the first and second ducts in communication with one another.

According to one alternative form, the exhaust system comprises a fuel injector opening into the first duct, an oxidation catalytic converter followed by a particulate filter connected to the second duct.

Other features and advantages of the invention will become clearly apparent from the description thereof given hereinafter by way of entirely nonlimiting indication with reference to the attached drawings, in which:

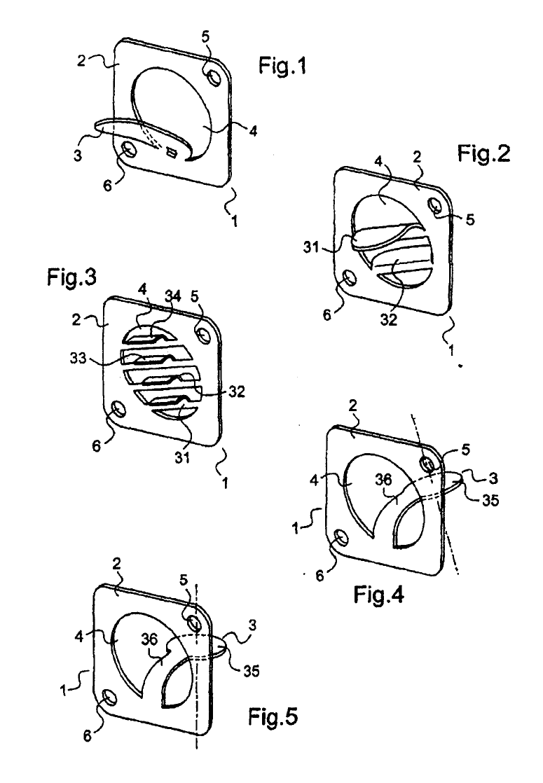

FIGS. 1 to 5 illustrate perspective views of various fuel homogenizing devices according to the invention, viewed from the upstream end;

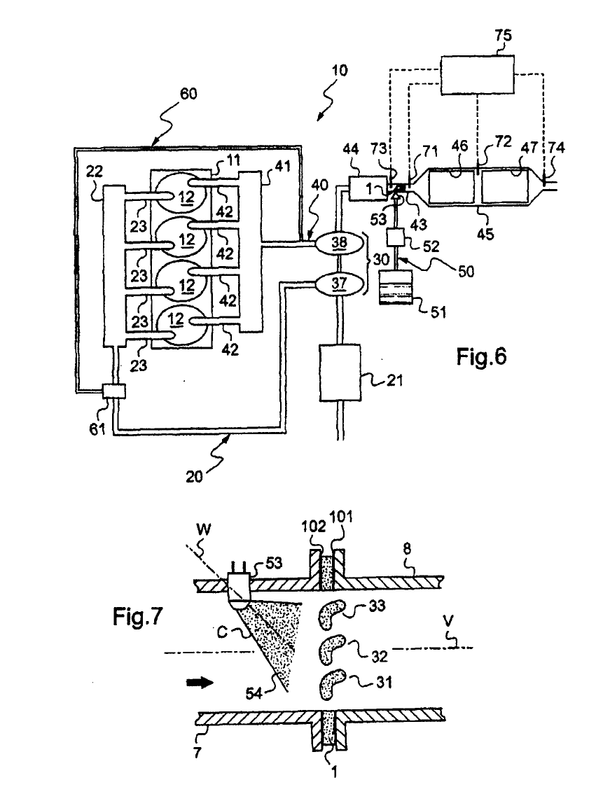

FIG. 6 illustrates a schematic general arrangement of a diesel-type combustion engine implementing such a homogenizing device;

FIG. 7 illustrates a sectioned view of a homogenizing device positioned in an exhaust pipe.

The invention proposes a device for homogenizing fuel in the gases of an exhaust system comprising a gas passage surrounded by a sealing surface. A deflection member projects toward the inside of the passage from the sealing surface and projects with respect to the plane of the sealing surface, the deflection member and the sealing surface being formed as a single piece.

In this way, good mixing of the fuel in the exhaust gases can be achieved upstream of the particulate filter. The vaporizing of the fuel is appreciably improved because the deflection member contributes to this evaporation in addition to the internal wall of the exhaust system. The risks of defective regeneration of the particulate filter are thus reduced. In addition, the one-piece structure of the homogenizing device makes it possible to produce it on an industrial scale at a low cost, for example by pressing or casting. This solution also makes it possible to reduce the size and/or the precious metal fill of the catalytic converter.

Hereinafter, the terms “downstream” and “upstream” will denote the direction in which the air flows, from the point at which the fresh air is tapped from the atmosphere until it leaves via a catalytic converter.

FIG. 1 illustrates a first alternative form of a homogenizing device 1 according to the invention. This device 1 comprises a substantially planar sealing surface 2 surrounding a passage 4 intended to have exhaust gases passed through it. The device 1 comprises a deflection member 3 projecting into the passage 4 from the surface 2 and projecting with respect to the plane of this surface 2. In order to withstand the temperatures of the exhaust gases, the sealing surface and the deflection member are advantageously made of a metallic material. This deflection member can thus intercept a jet of fuel passing through the exhaust system while at the same time generating a small pressure drop in the gas flow. The geometry of the member 3 illustrated is that of a tab that has the same width over most of its length. This tab extends across most of the passage and has a free edge. This tab forms a kind of trampoline for the flow. This form causes the gases to curl on either side, encouraging mixing. The member 3 overhangs the middle of the passage 4. This encourages evaporation by causing the jet of fuel to rise up toward the middle of the flow.

FIG. 2 illustrates a second alternative form of a homogenizing device 1 according to the invention. The device 1 comprises two deflection members 31 and 32 extending right across the passage 4. The deflection members 31 and 32 each have a fin projecting with respect to the plane of the surface 2 in opposite directions. This structure makes it possible to form two fuel-vaporizing stages that supplement the effect of the walls of the exhaust system. The fins illustrated are substantially parallel.

FIG. 3 illustrates an alternative form similar to that of FIG. 2. This alternative form has four deflection members 31 to 34 in order further to increase the number of vaporizing stages. Each deflection member has a fin, the fins being substantially parallel.

In FIGS. 4 and 5, the deflection member has a terminal part 35 exhibiting a free edge. A tab 36 that is inclined with respect to the sealing surface joins the terminal part 35 to the sealing surface 2. This tab 36 is of a width smaller than that of the terminal part 35. Because the terminal part 35 lies at the heart of the gas flow, the vaporizing of the fuel is appreciably improved in this region. In the example of FIG. 4, the tab 36 is twisted, for example as a result of a twisting operation performed at the time of forming. This can then significantly reduce the catching of the film of fuel deposited on the flanks and migrating in the direction of the gases. In the example of FIG. 5, the tab 36 is not twisted. Although the terminal part 35 in these examples is flat, it is equally possible to imagine producing one that is domed in one direction or the other.

FIG. 6 illustrates a schematic general arrangement of an internal combustion engine of the diesel type, implementing a homogenizing device according to the invention.

The internal combustion engine 10 comprises a combustion chamber 11 defined by four cylinders 12. Upstream of the combustion chamber 11, the engine 10 comprises a fresh air inlet system 20. This inlet system 20 takes fresh air directly from the atmosphere and filters it through an air filter 21. It extends as far as an air manifold 22 which opens onto four inlet tracts 23 each connected to one of the cylinders 12 of the combustion chamber 11.

The inlet system 20 further comprises a compressor 37 of a turbocompressor 30 which compresses the fresh air filtered by the air filter 21 in order to inject it under pressure into the air manifold 22. Downstream of the combustion chamber 11, the internal combustion engine 10 comprises an exhaust system 40 for the burnt gases, extending from an exhaust manifold 41, connected by four exhaust tracts 42 to each of the cylinders 12 of the combustion chamber 11, as far as the catalytic converter 45. This catalytic converter 45 here internally comprises an oxidation catalytic converter 46 followed, in the direction in which the burnt gases flow, by a particulate filter 47. The oxidation catalytic converter 46 is particularly suited to oxidizing hydrocarbons HC and carbon monoxide CO contained in the burnt gases flowing through the exhaust system 40.

The particulate filter 47 for its part is designed to filter and store the polluting particulates (also known as soot) produced by the combustion of fuel and fresh air in the combustion chamber 11, so as to prevent these from being discharged into the atmosphere. This filter has to be regenerated regularly in order that it should not become blocked by too great a quantity of polluting particulates. The particulate filter 47 may possibly be internally coated with a catalytic material, such as platinum, designed to oxidize hydrocarbons HC and carbon monoxide CO contained in the burnt gases.

The exhaust system 40 comprises an auxiliary oxidation catalytic converter 44 positioned upstream of the catalytic converter 45 and connected to the latter by an exhaust pipe 43 of circular cross section. This auxiliary oxidation catalytic converter 44 is intended to break down heavy hydrocarbons HC, so that they can be treated more readily and more quickly by the oxidation catalytic converter 46 of the catalytic converter 45. The exhaust system 40 additionally comprises, upstream of the auxiliary oxidation catalytic converter 44, a turbine 38 which is driven by the flow of burnt gases in order to drive the compressor 37.

The internal combustion engine 10 also comprises an exhaust gas recirculation line 60 which originates in the exhaust system 40, between the exhaust manifold 41 and the turbine 38, and which opens into the intake system 20, between the compressor 37 and the air manifold 22. The exhaust gas recirculation line 60 comprises, where it meets the inlet system 20, a valve 61 for regulating the flow of burnt gases reinjected into the combustion chamber 11 of the internal combustion engine 10. This exhaust gas recirculation line 60 makes it possible to reduce the volume of polluting emissions discharged by the internal combustion engine 10.

The internal combustion engine 10 further comprises means 50 of injecting fuel allowing fuel to be introduced directly into the exhaust pipe 43. These injection means comprise a fuel tank 51 connected to a pump 52 which takes fuel from this tank and conveys it under pressure to a fuel injector 53. The latter opens into the exhaust pipe 43. The injector 53 allows the desired amount of fuel to be sent to this pipe, at the desired moment. To this end, the opening and closing of the fuel injector 53 is controlled by electronic control means 75 of the internal combustion engine 10.

As illustrated in FIG. 6, the electronic control means 75 of the internal combustion engine 10 are connected to two pressure sensors 71, 74 designed to measure the difference in pressure between the inlet and outlet of the catalytic converter 45. This pressure difference is dependent on the level to which the particulate filter 47 is full of polluting particulates. The pressure sensors 71 and 74 are therefore able to determine the level of soiling of this filter.

The control means 75 are also connected to two temperature sensors 72, 73, one positioned in the exhaust pipe 43, just upstream of the injector 53, and the other positioned in the catalytic converter 45 between the oxidation catalytic converter 46 and the particulate filter 47. These temperature sensors continuously supply the control means 75 with two signals representative of the temperature of these gases when these gases have been treated by the oxidation catalytic converter. The control means can thus control the amount of fuel injected by the fuel injector 53 according to these measured temperatures, so that the burnt gases are at a desired temperature.

FIG. 7 illustrates a sectioned view through the exhaust pipe 43 associated with the homogenizing device in order to encourage the fuel injected into the burnt gases to evaporate and to encourage the homogenizing of the mixture. The exhaust pipe 43 comprises two ducts 7 and 8, assembled with one another by means known per se. The sealing surface 2 of one homogenizing device 1 is compressed between the ducts 7 and 8. Seals 101 and 102 are positioned on each side of the sealing surface, in contact with the ducts 7 and 8.

The inside of the ducts 7 and 8 is thus placed in communication via the passage of the homogenizing device 1. The oxidation catalytic converter 45 is connected downstream of the duct 8.

As illustrated in FIG. 7, the fuel injector 53 is advantageously designed to send a jet of fuel 54 into the injection cone C of central injection axis W. The fuel injector 53 is more specifically positioned in the exhaust pipe 43 in such a way that the central injection axis intersects the midline V of the exhaust pipe 43 and is inclined with respect to this midline V (the central axis of injection W is neither coincident with nor perpendicular to the midline V). The fins 31 to 33 of the deflection members are positioned in the injection cone C.

Although the homogenizing device 1 has been illustrated compressed between two ducts in FIG. 7, it is equally possible to imagine incorporating this device into an exhaust flange or positioning it at the inlet to the decoupling system, thus making it possible to reduce the number of joints needed to form the exhaust system.

1-11. (canceled)

12. A homogenizing device for homogenizing fuel in the gases of an exhaust system, comprising:
a substantially planar sealing surface surrounding a passage; and
a deflection member projecting into the passage from the sealing surface and projecting with respect to the plane of the sealing surface;
the sealing surface and the deflection member being formed as a single piece.

13. The homogenizing device as claimed in claim 12, wherein the sealing surface and the deflection member are made of a metallic material.

14. The homogenizing device as claimed in claim 12, wherein the sealing surface and the deflection member are formed as a single piece by casting.

15. The homogenizing device as claimed in claim 12, wherein the sealing surface and the deflection member are formed as a single piece by pressing.

16. The homogenizing device as claimed in claim 12, comprising plural of the deflection members extending right across the passage and each including a fin.

17. The homogenizing device as claimed in claim 16, wherein the fins are substantially mutually parallel.

18. The homogenizing device as claimed in claim 12, wherein the deflection member includes a terminal part exhibiting a free edge and a tab inclined with respect to the sealing surface, the tab connecting the terminal part to the sealing surface and being of a width smaller than that of the terminal part.

19. The homogenizing device as claimed in claim 18, wherein the tab is twisted.

20. The homogenizing device as claimed in claim 12, wherein the deflection member extends across most of the passage and includes a free edge.

21. An exhaust system, comprising:
an exhaust pipe comprising first and second ducts assembled with one another;
a homogenizing device as claimed in claim 12, the sealing surface of which is compressed between the first and second ducts and the passage of which places an inside of the first and second ducts in communication with one another.

22. The exhaust system as claimed in claim 21, further comprising:
a fuel injector opening into the first duct, and
an oxidation catalytic converter followed by a particulate filter connected to the second duct.
